(19) United States
(12) Patent Application Publication
(10) Pub. No.: US 2013/0183650 A1
(43) Pub. Date: Jul. 18, 2013

(54) Answer Text Knolwdge Network

(71) Applicant: John Eastman, Jackson, WY (US)

(72) Inventor: John Eastman, Jackson, WY (US)

(21) Appl. No.: 13/302,239

(22) Filed: Nov. 22, 2011

Related U.S. Application Data
(60) Provisional application No. 61/417,069, filed on Nov. 24, 2010.

(51) Int. Cl. G09B 7/06

(52) U.S. Cl. CPC G09B 7/06
USPC 434/335; 434/322

(57) ABSTRACT

A messaging system using text-messaging protocol (limited to 160 characters) for automated delivery, at user-defined intervals, of multiple-choice questions (“Challenges”) to targeted electronic devices. The individual to whom the Challenges are directed, or adult in the case of a minor, must self-select their profile and opt-in to the service; no unsolicited Challenges are allowed to be delivered. The outcome of the interaction with the system is an award that is measured in objective, alpha-numeric values (“Achievements”).

### CROSS REFERENCED APPLICATIONS

None.

### JOINT RESEARCH AGREEMENT

None.

### SEQUENCE LISTING

None.

### BACKGROUND

This application follows the provisional application No. 61/417,069, filed Nov. 24, 2010.

A primary distraction for young adults age 14-22, from learning in school is their obsession with sending and receiving text messages. The platforms and devices for texting-as-the-preferred-communication medium among this demographic has continued to grow, and as a result, parents grow inpatient, teachers are increasingly distracted from teaching and teens are disconnected from what matters most—learning.

Most schools treat the phone as a disruptive force that must be managed and often excluded from the school and the classroom. Even though most schools treat the phone as something to be contained and regulated, teens are nevertheless still texting frequently in class.

65% of cell-owning teens at schools that completely ban phones bring their phones to school every day.

58% of cell-owning teens at schools that ban phones have sent a text message during class.

43% of all teens who take their phones to school say they text in class at least once a day or more.

Just as compelling, and to complicate this obsession with texting, cell-phone texting has become the preferred channel of basic communication between teens and their friends and cell calling is a close second. Some 75% of 12-17 year-olds now own cell phones, up from 45% in 2004. Those phones have become indispensable tools in teen communication patterns.

Fully 72% of all teens are text-messagers, a sharp rise from the 51% of teens who were texters in 2006. More than half of teens (54%) are daily texters. Among all teens, the frequency of use of texting has now overtaken the frequency of every other common form of interaction with their friends (instant messaging, calls, social networking, face-to-face). Fully two-thirds of teen texters say they are more likely to use their cell phones to text their friends than talk to them to them by cell phone.

Given the nature of teens as a fiercely independent demographic, and these trends in communication mediums, instead of fighting this distraction with punitive controls Answer TXT seeks to use this platform to present learning opportunities for the teens.

### DRAWINGS

Ten drawings that document the workflow for the AnswerTxt system are detailed below and are submitted in a separate application part titled Drawings.

FIG. 1—Overall software model as architected for the program.

FIG. 2—Simple flowchart of the Answer Text Network.

FIG. 3—Detailed flowchart of the Answer Text Network.

FIG. 4—Structure of the Challenges and variables for selection.

FIG. 5—Rules for Frequency of Challenge sent.

FIG. 6—Rules for Inactivity in response to Challenge sent.

FIG. 7—Editor workflow for managing Challenges.

FIG. 8—Parent (owner) workflow for profile of Challenges.

FIG. 9—Student workflow for sending responses & reporting.

FIG. 10—Model diagram for the Answer Text Network.

### DETAILED DESCRIPTION

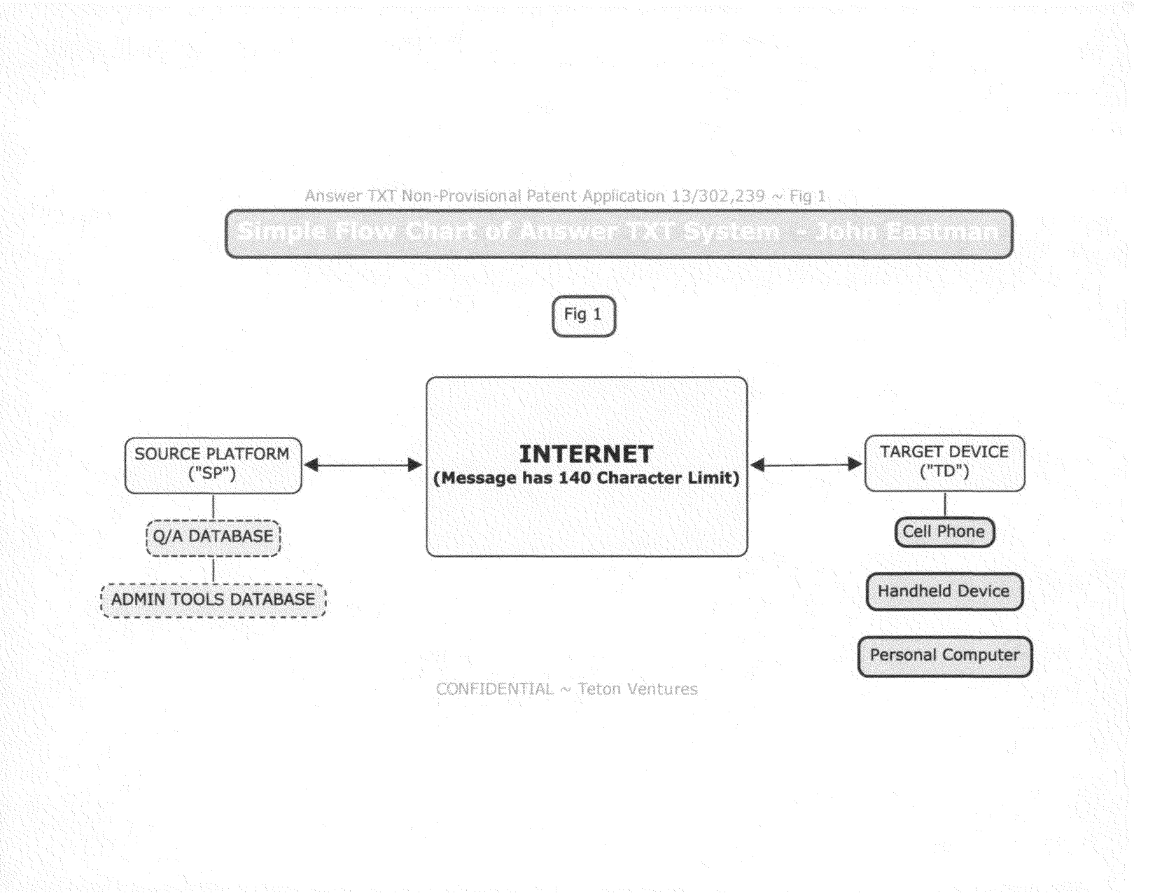

### Overall Computer Architecture of the Answer TXT Network. (See FIG. 1.)

A main server Source Platform (“SP”) is the repository of the database of content consisting of questions and the answers associated with that question—the Questions & Answers Database, one of which is the correct answer and 3 of which are incorrect answers. The questions and answers are created through an administrative editorial platform that is managed by trusted authenticated users who define the question and associated answers. The questions and answers are organized hierarchically by subject and by level of difficulty as defined by the user and system-authorized editor. The SP connects to a Web portal that can send and receive messages to/from a Target Device (“TD”) like a cell phone, an instant message device, another website with user accounts like Skype, Facebook, etc.)

The SP also hosts an Administrative Database for operator-selected tools which manage the type of questions that are presented, the format of the questions and answers, the frequency with which the questions are delivered to a TD the type of target device to be coupled with the SP, the consequence of inactivity with the system, and the user information that is required for the coupling of the SP and the TD.

The main server is connected to the Internet through standard TCP/IP protocol.

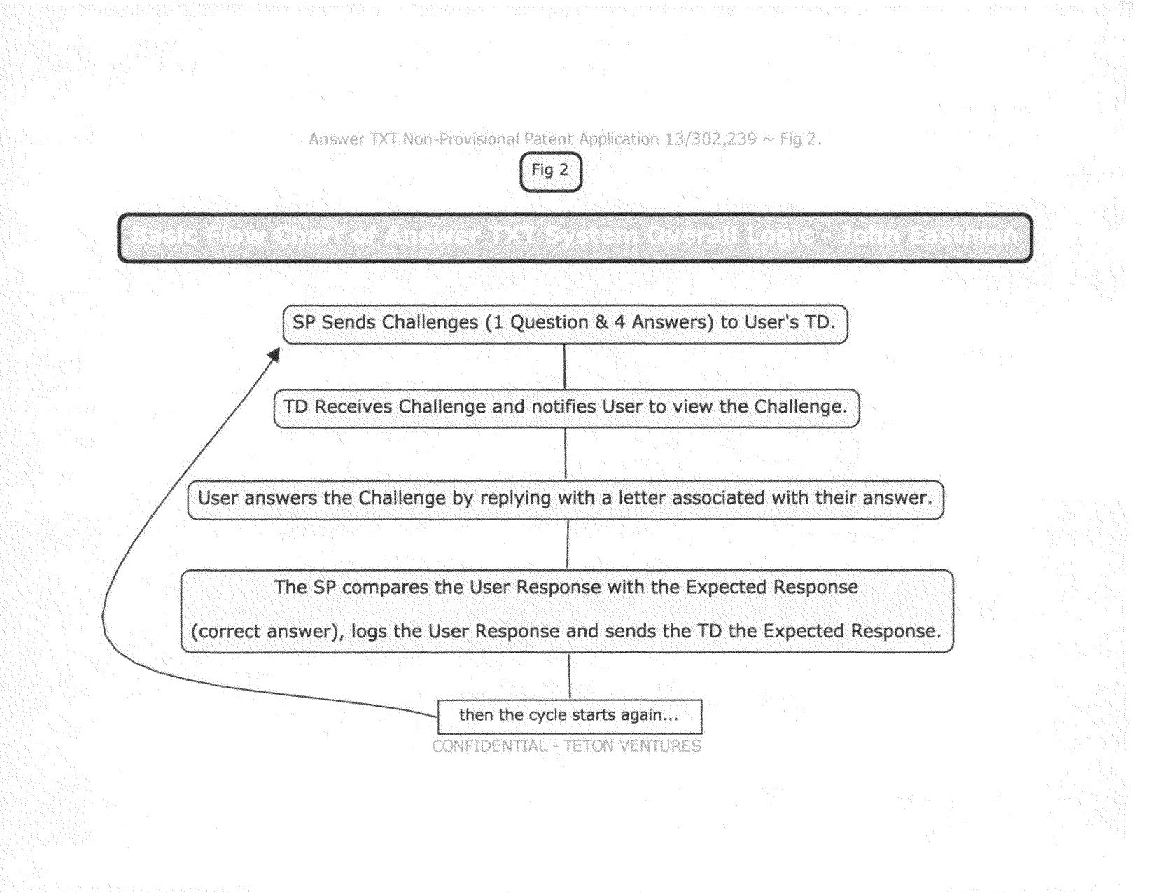

### Basic Flow Chart of the Answer TXT System. (See FIG. 2.)

This Internet connection allows the SP to deliver the questions and answers (“Challeges”) to the TD for presentation to the user of the TD. The user responds to the Challenge from their TD and this answer is transmitted back through the internet to the server where the Answer TXT software parses the user response and compares this to the expected response (the correct answer) that is associated with that Challenge in the database. The SP then logs the response and sends the expected response to the user.

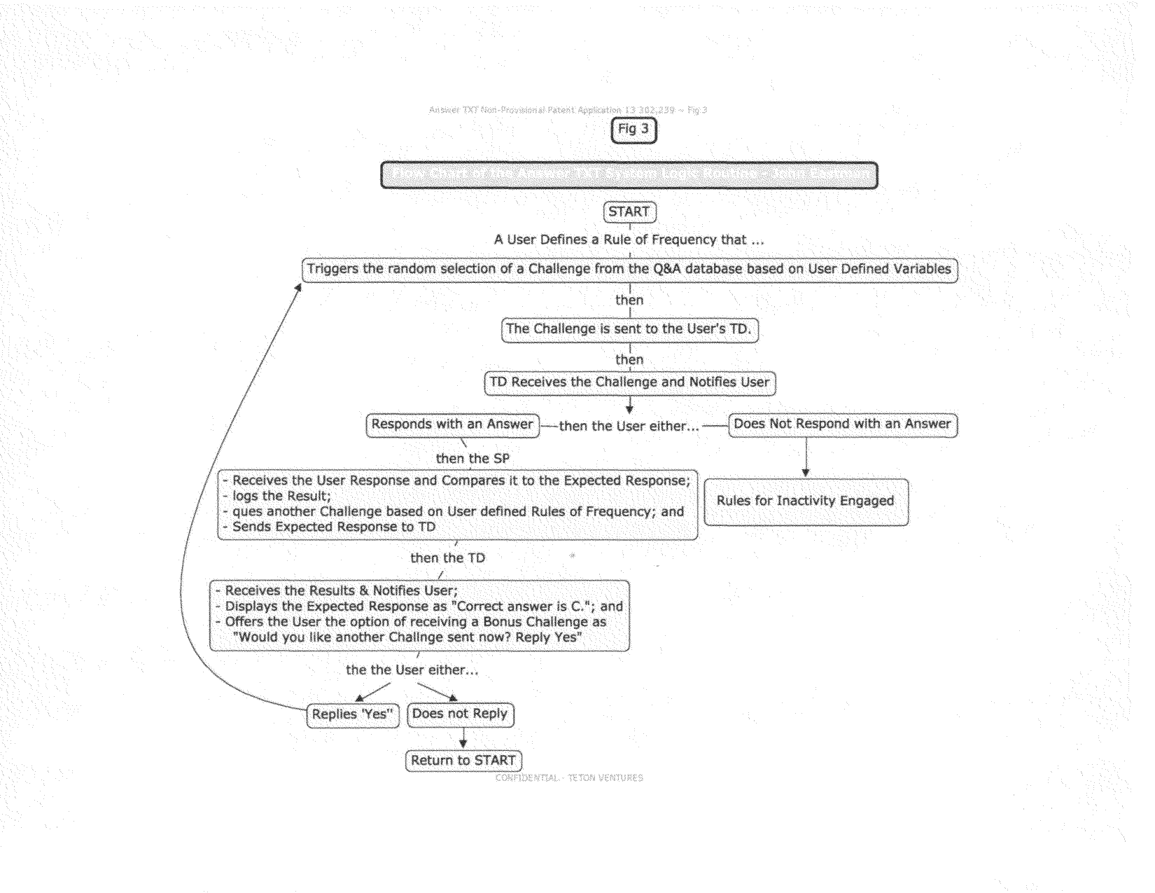

### Detailed Flow Chart of the Answer TXT System Logic Routine. (See FIG. 3.)

The System, not the user, initiates the sending of a Challenge to the user; however the user defines the rule for when to send a Challenge to the user's TD (“Frequency Rules”) based on either time or volume of messages. The type of Challenge that is sent is also defined by the user through a selection of variables, which options are presented to the user in the Administrative Database.

When the Challenge is received by the TD, the user has the option of either responding to the Challenge or not responding to the Challenge.

If the user responds to the Challenge, they select the letter associated with their response and reply to the Challenge message with this letter (“User Response”). The SP then receives the User Response and compares this with the correct answer to the question identified in the database (“Expected Response”); logs this User Response (“Result”); randomly selects another Challenge from the Questions and Answers Database that match the User Defined set of variables; and sends the Expected Response to the user's TD. The SP reports on the performance of each TD for Results that match, and Results that do not match the Expected Response.

The Expected Response sent to the TD also contains an option for the User to request another Challenge be sent immediately. If the User elects to have another Challenge sent immediately, then the User replies “Yes”, and when the SP then receives this reply, the Challenge that is in the Que is sent immediately.

If the User does not respond to the Challenge, then on the fourth Challenge sent with no User Response, the Rules for Inactivity are engaged. These User Defined Rules for Inactivity offer the option of either disabling the access to the messaging platform on the TD for a defined number of hours, sending a message to the TD that the volume of messaging is too high, or not taking any action. Once the Rules for Inactivity have been applied, the Rules for Frequency will once again be active.

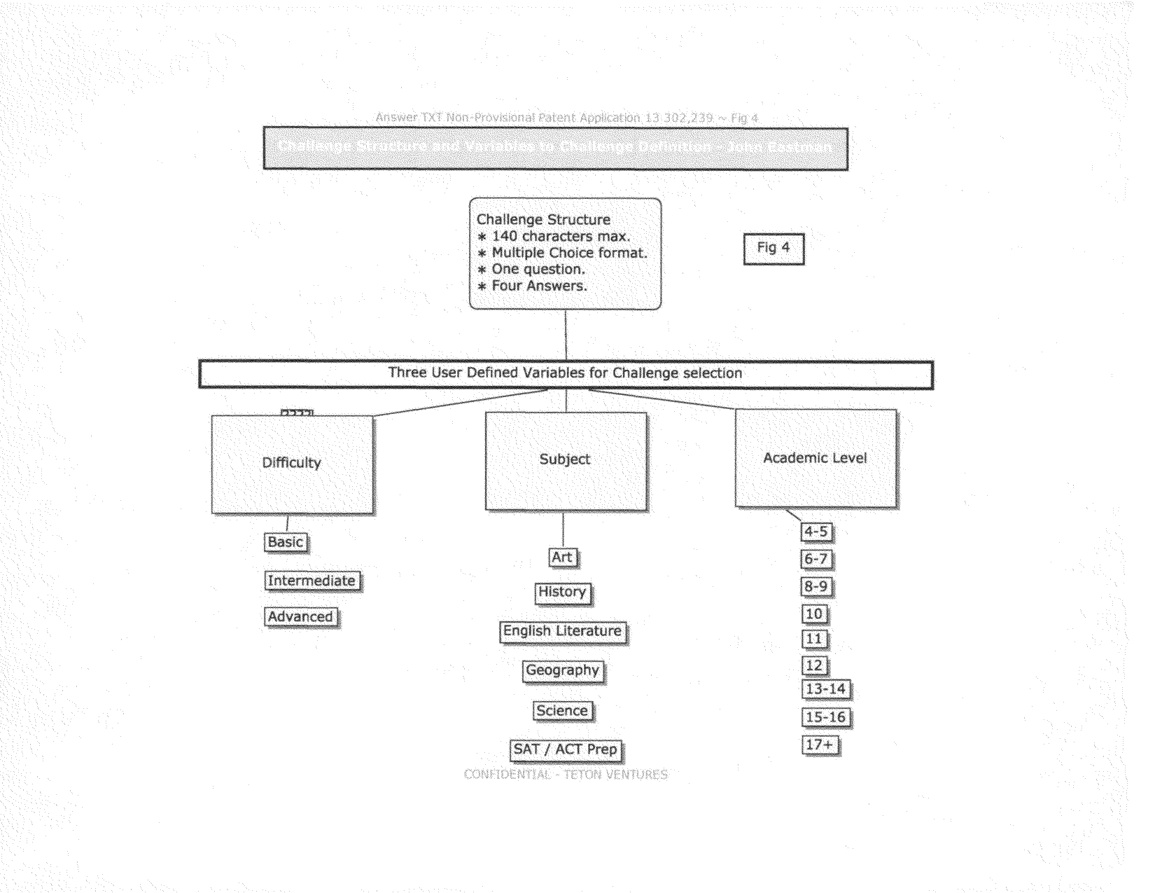

### Challenge Structure and Variables to Challenger Definition. (See FIG. 4.)

Challenges are randomly selected from the Question and Answer Database. The domain from which the Challenge is selected is defined by the User. The Variables that the User must select from include the Difficulty (Basic, Intermediate, Advanced); the Subject (Art, History, English Literature, Geography, Science, SAT/ACT Preparation, etc.); and the Academic Level (a range from 4th grade through post graduate levels).

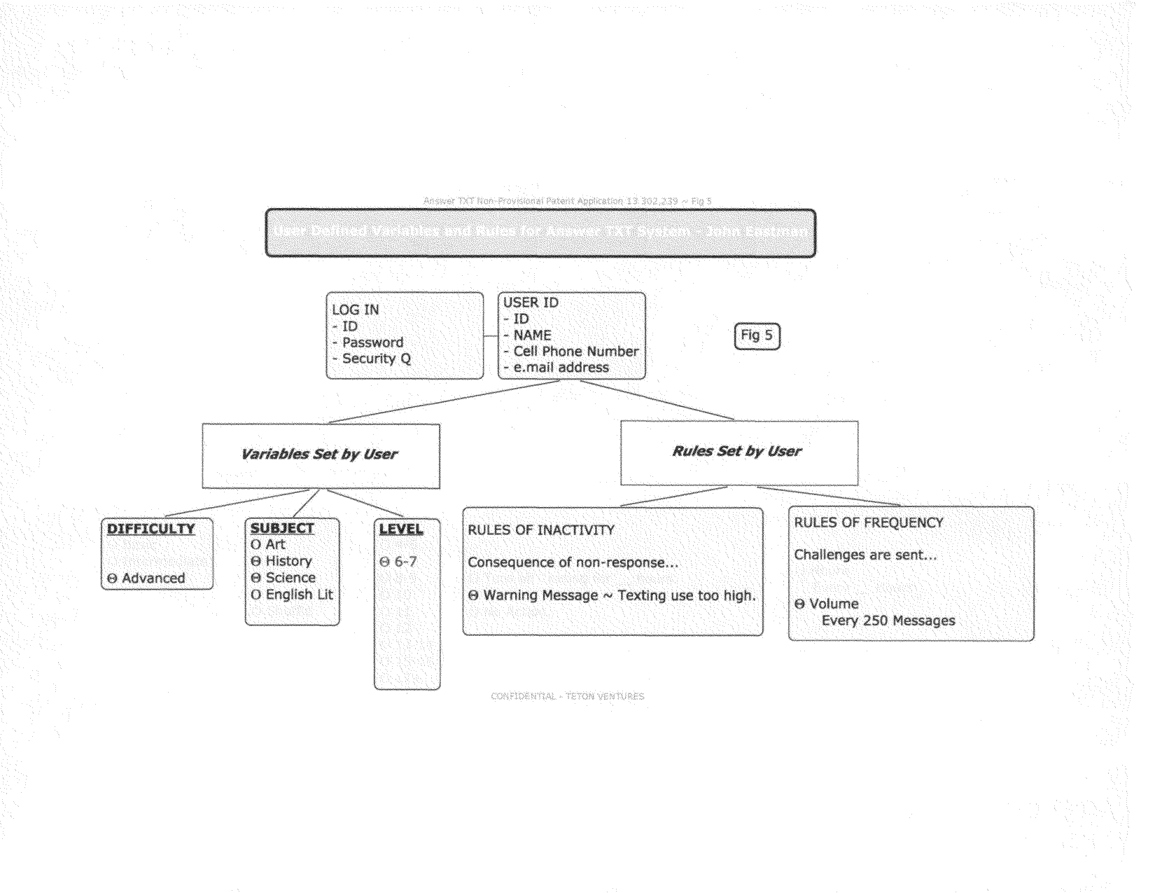

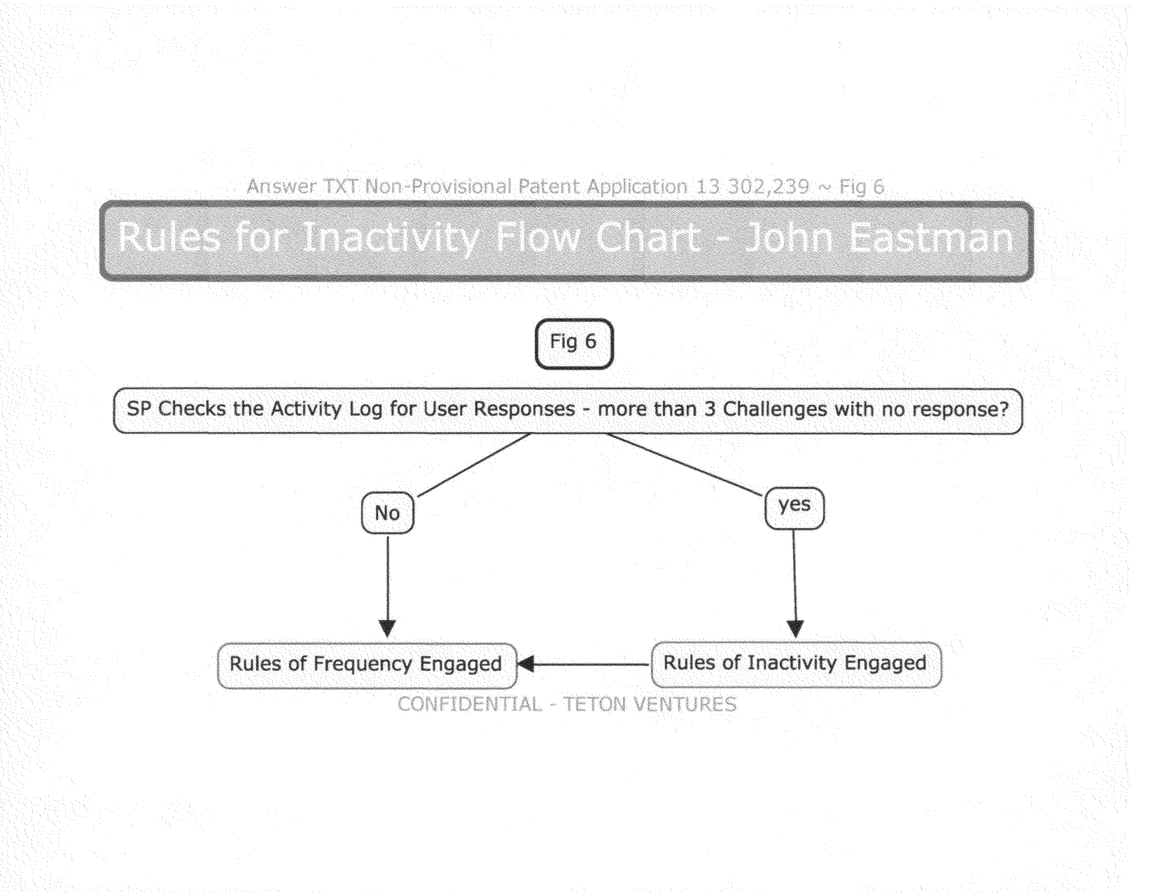

### Rules for Frequency and Inactivity. (See FIG. 5. & FIG. 6.)

In addition to the Challenger definition Variables, there are rules that govern both how often a Challenge is sent (“Rules for Frequency”) and the consequence of inactivity by the User (“Rules for Inactivity”). The User can elect how often the System will initiate a Challenge by either setting the Frequency metric based on units of time or on units of volume of messages that the User sends or receives on the TD. The User can elect how the System responds to Inactivity by either having the System disable the messaging on the TD for a period of time; sending a warning message to the User that their volume of messaging is too high; or take no action.

After the fourth consecutive Challenge is registered without a User Response, the SP engages the Rules for Inactivity. These Rules are User Defined and after the selected consequence of Inactivity is completed, then the SP engages the Rules for Frequency.

### Data Model

The core element of the system is a Challenge, which contains a question with three possible answers, one of which is identified as the correct answer. Each Challenge has an associated Level, Grade and Subject. Challenges are also associated with the User (editor) that entered the Challenge. Only active Challenges are used by the system.

Each time a student User responds to a Challenge, a Response is created. The Response tracks each answered Challenge and contains the User that answered, which of the answer choices was received and when the answer occurred. The Responses are the basis of all student User reports.

### User Types

The AnswerTXT system supports four distinct user types:

Administrator—staff User that can access all elements of the system, including ability to change type setting for users (e.g. to set a user to editor type). This user also sets up the Levels, Grades, and Subjects.

Editor—User that can enter Challenges. This User can review entered Challenges, modify inactive Challenges and see statistics on Student performance for active Challenges. Only Challenges entered by this User are accessible. An editor is owned by another editor User or an administrator User. The owning User must activate Challenges. This provides a supervisory structure to the editorial process.

Parent—User that can enable system for a student User. This user species delivery details for one or more student Users (Levels, Grades, Subjects and TargetDevices) and can access performance reports of those Users.

Student—User answers Challenges when promoted. This user can access his/her own performance reports.

### Administrator Workflow

An administrator accesses the web site and creates an account by entering first and last names, zip code, an email address, password. The administrator can login to the site once another administrator User has approved this administrator by setting the User to active. The system is seeded with an original administrator.

When logged in, the administrator can see all other administrator and editor Users, view and edit their active status, and view/edit their hierarchy (i.e. which editors “own” other editors). The editor hierarchy allows some editors to be supervisors to other editors and therefore able to approve (activate) Challenges submitted by the other editors.

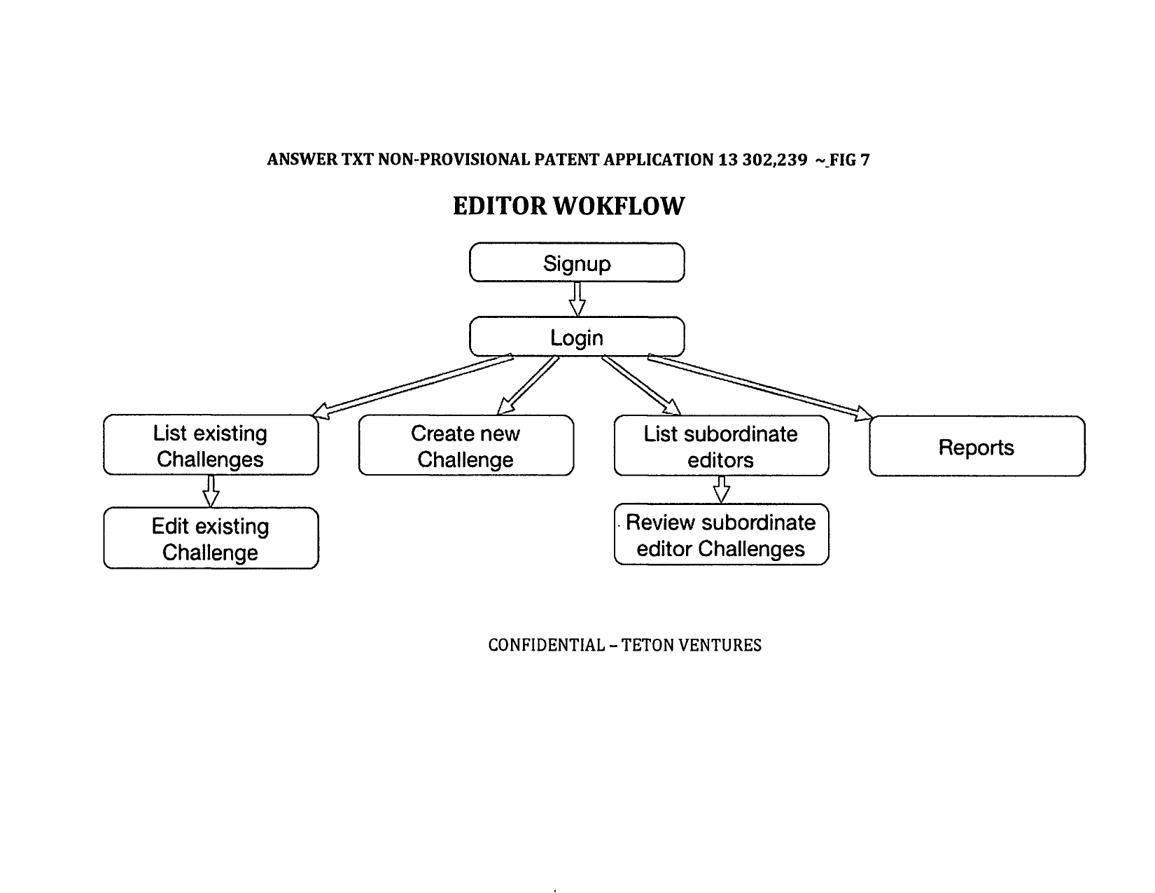

### Editor Workflow (see FIG. 7)

A new editor accesses the web site and creates an account by entering first and last names, zip code, an email address, password. The editor can login to the site once an administrator User has approved the editor by setting the User to active. When logged in, the editor can review all existing Challenges entered by the editor, create new Challenges and edit inactive Challenges.

To create a new Challenge, the editor selects a Level, Grade and Subject, and then enters the Challenge question and three answers. One answer must be identified as the correct answer. The system automatically ensures each Challenge (question and answers) fits within the maximum character count to support the various Target Devices (currently the 160 character SMS limit)

The supervisor for this editor (an editor or administrator User that owns this editor User) must approve the Challenge by setting it to active.

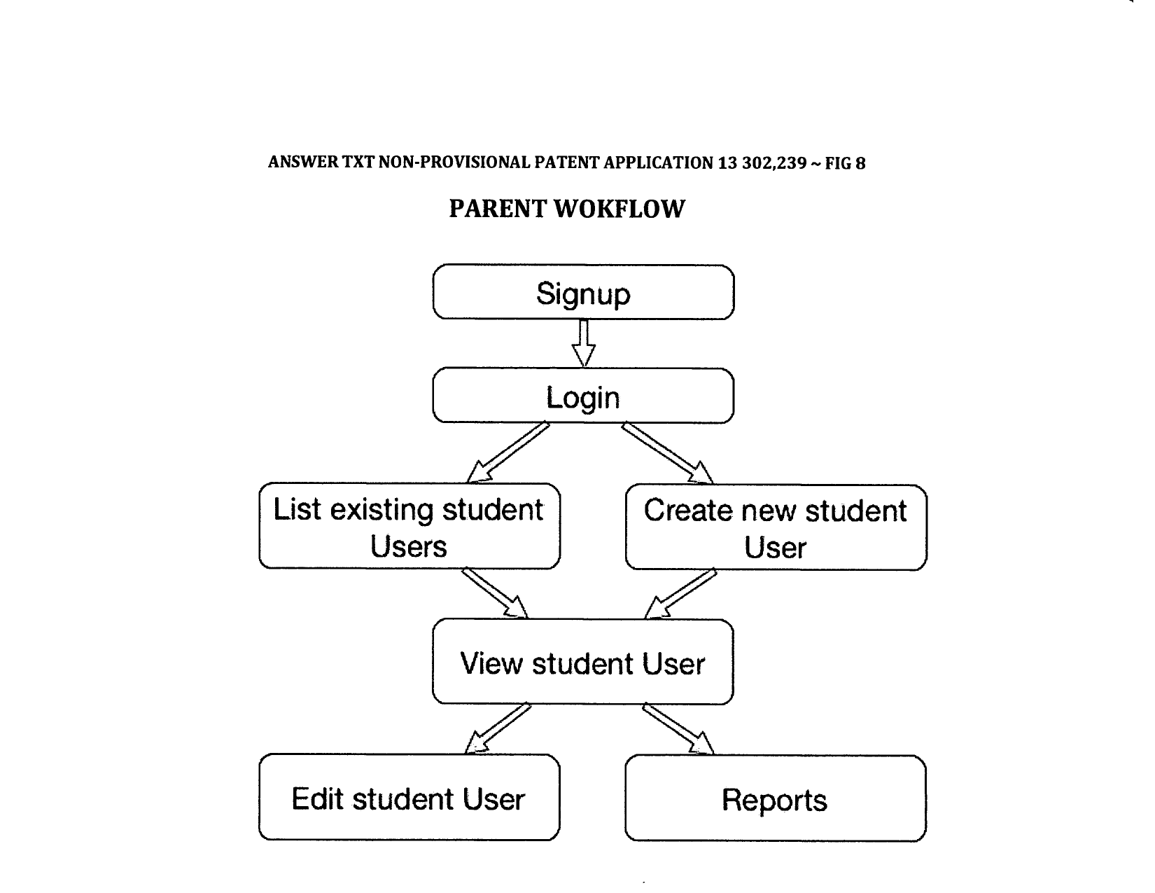

### Parent Workflow—(see FIG. 8)

A new parent access the web site and creates an User account by entering first and last names, zip code, an email address and password. The email address must be unique to the system. Parent and associated student Users are automatically active. The parent then creates User accounts for one or more students. These student Users are owned by the parent User.

When creating a student User account, the parent also specifies the desired Level, Grade and Subjects for the student, as well as details on the Target Device to which Challenges will be sent. The parent can login to the web site and access performance reports on Sent Challenges and Responses for each owned student User.

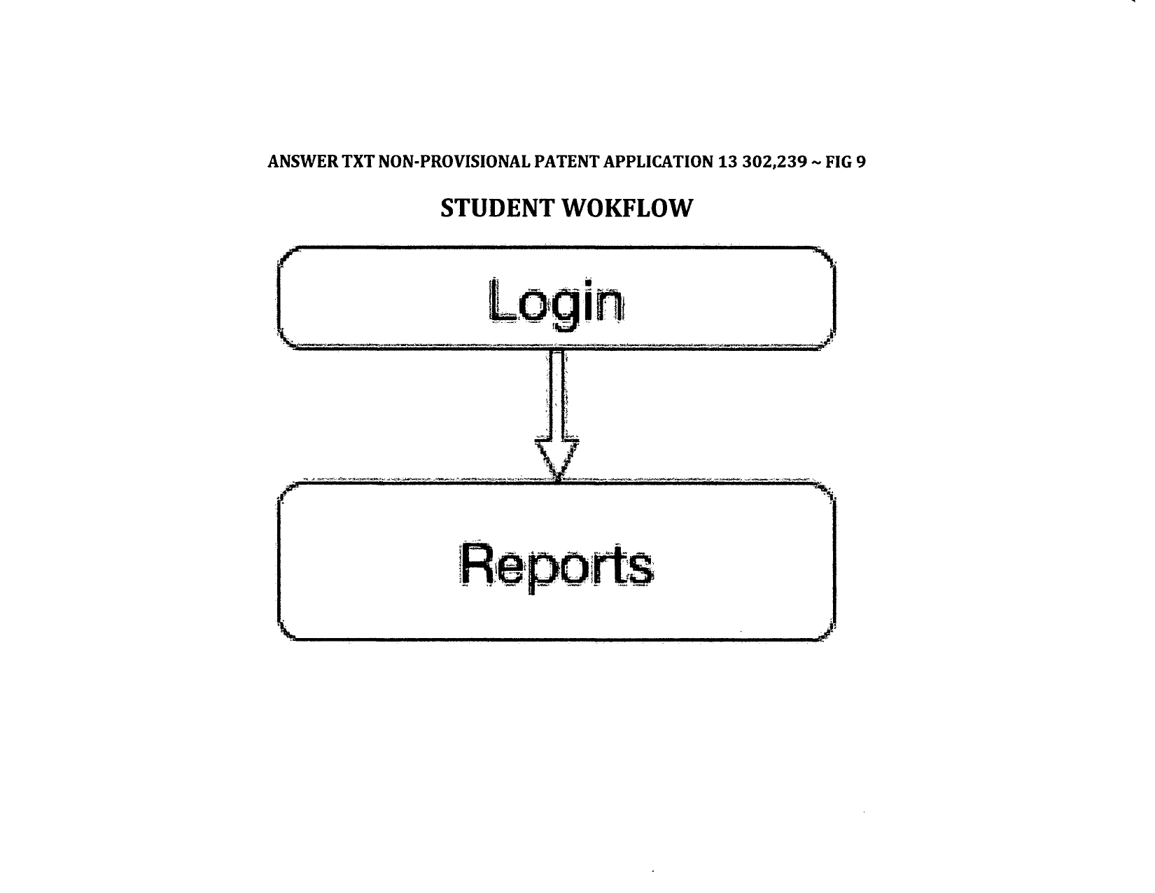

### Student Workflow (see FIG. 9)

A student receives Challenges on their Target Device. Each Challenge sent is logged with a timestamp as a Sent Challenge. Each answer from student is logged with a timestamp as a Response. When a Response is received, a message is sent to the student indicating if answer was correct.

The student can login to the web site, using the User account created by the parent, and access performance reports on their Sent Challenges and Responses.

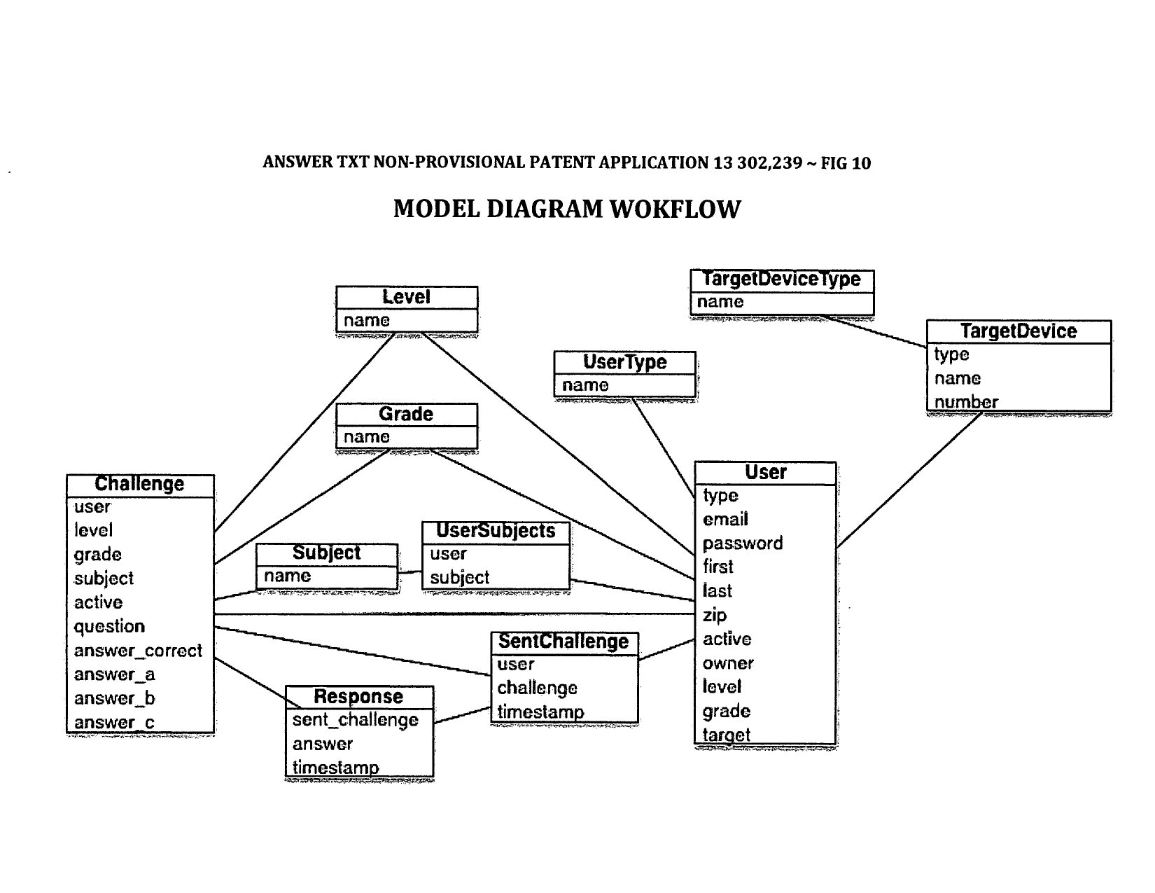

### Model Diagram (see FIG. 10)

The basic model (database entities and their relationships) for the system, not including the gateway components necessary to send and receive message with Target Devices.

### GLOSSARY

SP—Source Platform. The website portal that contains the user interface for administration/selecting rules, manages db of questions & answers, connects to the remote target devices including other websites.
TD—Target Device. A cell phone, iTouch, web account of third party social media site, etc.
Challenge—a question and four multiple choice (letter) answers.
User—the person who receives the challenge.
UR—User Response. The user's selected answer to the challenge sent to the SP.
ER—Expected Response. The correct answer to the challenge.
Challenge Type. Challenges are sorted into Subjects, and each subject is further sorted into Levels and each level has three degrees of difficulty (Basic, Intermediate, Advanced).
FC—Frequency of Challenge. The amount of time between challenges, measured in units of hours. This frequency can be positively altered by correct answers to bonus challenges, or negatively altered by three consecutive incorrect answers.
CI—Consequence of Inactivity. What happens when no response is given to the Challenge?
BC—Bonus Challenge. This is an additional challenge elected by the user after submitting an expected response to a Challenge. Submitting an expected response to a BC will extend the FC.
AD—Administrative Database. Provides the tools for setting the rules and parameters for the Challenges.

1. The Answer Txt network system delivers multiple choice questions and/or answers to individuals through electronic text messaging media at random intervals.

2. The Answer Txt network system allows the intervals of message delivery to be governed by time or by volume of messages, which are transmitted across the network to an individual device.

3. The Answer Txt network system enables the creation and publication of the multiple choice questions and answers, that are compatible for transmission across the network system, by any individual.

4. The Answer Txt network system rewards correct answers through achievements.

5. The Answer Txt network system organizes questions in customized categories (e.g. age, school level, subject).

6. The Answer Txt network system reports on performance (number of correct and incorrect answers in specified time windows and question categories) of individual devices.

7. The Answer Txt network system enables a hierarchical author/editor network to distribute question submission and provide an editorial review capability.
